(19) United States
(12) Patent Application Publication
(10) Pub. No.: US 2024/0184982 A1
(43) Pub. Date: Jun. 6, 2024

(54) HIERARCHICAL TEXT GENERATION USING LANGUAGE MODEL NEURAL NETWORKS

(71) Applicant: DeepMind Technologies Limited, London (GB)

(72) Inventors: Kory Wallace Mathewson, Montreal (CA); Piotr Wojciech Mirowski, London (GB); Richard Andrew Evans, London (GB)

(21) Appl. No.: 18/527,211

(22) Filed: Dec. 1, 2023

Related U.S. Application Data
(60) Provisional application No. 63/429,532, filed on Dec. 1, 2022.

(51) Int. Cl. G06F 40/20

(52) U.S. Cl. CPC G06F 40/20

(57) ABSTRACT

Methods, systems, and apparatus, including computer programs encoded on computer storage media, for generating long textual works using language model neural networks. For example, the textual works can be generated hierarchically by performing a hierarchy of generation steps using the same language model neural network.

### CROSS-REFERENCE TO RELATED APPLICATION

This application claims priority to U.S. Provisional Application No. 63/429,532, filed on Dec. 1, 2022. The disclosure of the prior application is considered part of and is incorporated by reference in the disclosure of this application.

### BACKGROUND

This specification relates to processing inputs using neural networks to generate text.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that hierarchically generates a textual work using a language model neural network. Thus, the system uses the same auto-regressive neural network to perform each generation step in a hierarchy of generation steps to generate the actual text of the textual work.

The subject matter described in this specification can be implemented in particular embodiments so as to realize one or more of the following advantages.

Language model neural networks have shown promise for a variety of text generation tasks. However, while language model neural networks can be used to generate high-quality text, they have difficulty with generating long-term semantic coherence due to the restricted size of their context windows, i.e., restricted length of the current input sequence at any given time step. In particular, language model neural networks apply self-attention over their inputs, meaning that the amount of memory required to generate a given output token scales quadratically with the number of tokens in the current input sequence.

In other words, the amount of memory required to generate the next token in the output sequence is O(n²) (where n is the number of tokens in the current input sequence). Thus, due to the constrained memory space of the one or more computers on which the neural network is deployed, the language model neural network must operate with a limited context window size, i.e., with a limited maximum length for the current input sequence when generating any given token. When the current input sequence exceeds the context window size, the neural network removes the earliest tokens in the current input sequence so that the length of the current input sequence fits into the context window size prior to processing the current input sequence using the neural network 110. For example, given the memory constraints described above, the context window size may be limited to 2048 tokens.

However, generating a long text output that has many sections that need to be internally consistent and coherent requires generating text of a length that far exceeds the context window size. Moreover, the texts are required to exhibit long-term semantic coherence, with entities referenced at one point in the textual work being consistently referenced and described throughout the long textual work. For example, narratives require long-term semantic coherence between actors and their actions across the entire narrative. Because of the limited context size, an entity that only appears outside of the current context window is unlikely to be correctly referenced by the language model. Thus, language models are, by default, ill-suited for being used to generate long, semantically-coherent texts due to their large memory consumption and the constrained memory space of modern computing devices, e.g., general purpose computers or specialized neural network accelerators.

The described techniques overcome these difficulties by generating the textual work across a hierarchy of generation steps, with each individual generation step fitting within the context window of the neural network. This ensures that no individual generation step exceeds the amount of memory available for performing inference using the neural network (or requires the neural network to condition on a context that is significantly longer than during training of the neural network).

In particular, the hierarchy includes a layer at which a respective summary is generated for each of multiple sections within the output. Because each summary satisfies the specification of outputs generated at earlier layers in the hierarchy and causality requirements with respect to earlier summaries of earlier sections in the sequence, the system can then generate the text of each of the sections independently, allowing the generation to fit within the context window size while still ensuring that the generated section text is semantically coherent across sections.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example text generation system.

FIG. 2 is a diagram of one example of a hierarchy of generation steps.

FIG. 3 shows an example prompt for an example generation step.

FIG. 4 shows an example user interface.

FIG. 5 is a flow diagram of an example process for generating a textual work.

Like reference numbers and designations in the various drawings indicate like elements.

### DETAILED DESCRIPTION

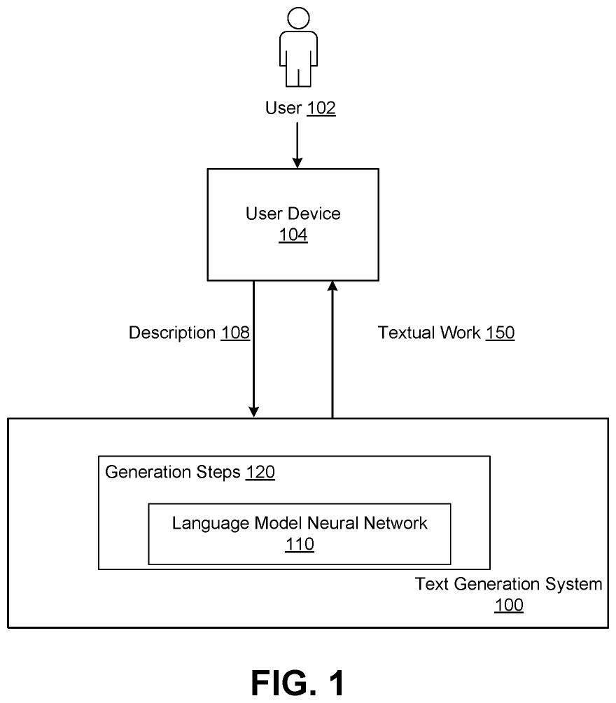

FIG. 1 shows an example textual work generation system 100. The textual work generation system 100 is an example of a system implemented as computer programs on one or more computers in one or more locations, in which the systems, components, and techniques described below can be implemented.

The textual work generation system 100 is a system that generates textual works 150 in response to received requests.

For example, the system 100 can receive a request from a user 102 of a user device 104 and, in response, generate a textual work 150 and provide the textual work 150 for presentation to the user 102 of the user device 104.

The system 100 can be implemented as one or more computer programs on the user device 104 or on one or more computer programs on one or more computers that are remote from the user device 104. In the latter case, the system 100 can communicate with the user device 104 through a wired or wireless network connection.

A structured textual work is a text in a natural language having a plurality of sections.

A section may be an explicit section, e.g., a section denoted by a title, heading, subheading, header, section marker. Alternatively, a section may be an implicit section, e.g., a section indicated by a transitional phrase or narrative break or transitional code comment. While a structured textual work has multiple sections, two or more of the plurality of sections share one or more properties such that coherence is maintained throughout the textual work.

For example, the structured textual work may be a scientific paper. The scientific paper may include several sections, each of which relates to a different experiment each performed using a central method described in the paper. While the particular experiments warrant distinct sections, each should coherently refer to the central method and its properties. Properties of the central method that should be coherently referred to may include, for example, equipment used, units of measurement used, measurement techniques used, and the location of the experiment.

Another example of a structured textual work is a text narrative. A text narrative is natural language text in a particular natural language that describes a sequence of actions that are performed in an environment. For example, the text narrative can be a screenplay, a theater script or other narrative that includes dialogue between multiple agents in the environment. These text narratives all have multiple scenes, which may be explicitly or implicitly separated from one another within the narrative. As another example, the text narrative can be a description of actions performed by agents in a computer simulation of a real-world interaction in a real-world environment.

Another example of a structured textual work is an essay. In an essay, an author may set out multiple different perspectives on a given issue, provide evidence for each of these multiple perspectives, discuss these perspectives, then draw a conclusion. The sections may be implicit, e.g., indicated by transitional phrasing. For example, the sections of an essay may include an introductory section, a plurality of descriptive sections, each describing one of a plurality of perspectives, a plurality of discussion sections comparing and contrasting a subset of the plurality of perspectives and a conclusion section. For example, the essay may be a philosophical essay in which philosophical perspectives are set out, analyzed and discussed to draw a conclusion. Throughout the essay, the definitions of these philosophical perspectives should be consistently referred to throughout the sections, evidence for each of these positions should be consistently referred to, and the names, birthdates and geographic origin of philosophers should be consistent throughout.

In some implementations, the system 100 can generate textual works 150 unprompted, i.e., without conditioning on any user-specified context input. In these implementations, the system 100 can generate a high-level description 108 of the contents of the textual work and process the high-level description 108 to generate the textual work 150. For example, the system 100 can query a chat bot or other generative model to generate a high-level description 108. As another example the system can prompt the language model neural network 110 described below to generate the description 108.

The high-level description is a summary of the desired contents of the textual work 150.

In some other implementations, the system 100 can receive the high-level description 108 from the user 102 of the user device 104.

The system 100 uses the high-level description 108 to generate the textual work 150 using an auto-regressive language model neural network 110.

The language model neural network 110 is referred to as an auto-regressive neural network because the neural network 110 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence. For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence 120, the neural network 110 can process the current input sequence to generate a score distribution, e.g., a probability distribution, that assigns a respective score, e.g., a respective probability, to each token in the vocabulary of tokens. The neural network 110 can then select, as the particular token, a token from the vocabulary using the score distribution. For example, the neural network 110 can greedily select the highest-scoring token or can sample, e.g., using nucleus sampling or another sampling technique, a token from the distribution.

As a particular example, the language model neural network 110 can be an auto-regressive Transformer-based neural network that includes (i) a plurality of attention blocks that each apply a self-attention operation and (ii) an output subnetwork that processes an output of the last attention block to generate the score distribution.

The neural network 110 can have any of a variety of Transformer-based neural network architectures. Examples of such architectures include those described in J. Hoffmann. S. Borgeaud. A. Mensch. E. Buchatskaya. T. Cai. E. Rutherford. D. d. L. Casas. L. A. Hendricks. J. Welbl. A. Clark, et al. Training compute-optimal large language models. arXiv preprint arXiv:2203.15556. 2022: J. W. Rae. S. Borgeaud. T. Cai, K. Millican. J. Hoffmann. H. F. Song. J. Aslanides. S. Henderson. R. Ring. S. Young. E. Rutherford. T. Hennigan. J. Menick. A. Cassirer. R. Powell. G. van den Driessche. L. A. Hendricks. M. Rauh. P. Huang. A. Glaese. J. Welbl. S. Dathathri. S. Huang. J. Uesato. J. Mellor. I. Higgins. A. Creswell. N. McAleese. A. Wu. E. Elsen. S. M. Jayakumar. E. Buchatskaya. D. Budden. E. Sutherland, K. Simonyan, M. Paganini. L. Sifre. L. Martens. X. L. Li. A. Kuncoro. A. Nematzadeh. E. Gribovskaya. D. Donato. A. Lazaridou. A. Mensch. J. Lespiau. M. Tsimpoukelli. N. Grigorev. D. Fritz. T. Sottiaux. M. Pajarskas. T. Pohlen. Z. Gong. D. Toyama. C. de Masson d'Autume. Y. Li. T. Terzi. V. Mikulik. I. Babuschkin. A. Clark. D. de Las Casas, A. Guy. C. Jones. J. Bradbury. M. Johnson. B. A. Hechtman. L. Weidinger. I. Gabriel. W. S. Isaac. E. Lockhart. S. Osindero. L. Rimell. C. Dyer. O. Vinyals. K. Ayoub. J. Stanway. L. Bennett. D. Hassabis. K. Kavukcuoglu. and G. Irving. Scaling language models: Methods. analysis & insights from training gopher. CoRR. abs/2112.11446. 2021: Colin Raffel. Noam Shazeer. Adam Roberts. Katherine Lee. Sharan Narang. Michael Matena. Yanqi Zhou. Wei Li, and Peter J Liu. Exploring the limits of transfer learning with a unified text-to-text transformer. arXiv preprint arXiv: 1910.10683. 2019; Daniel Adiwardana. Minh-Thang Luong. David R. So. Jamie Hall. Noah Fiedel. Romal Thoppilan. Zi Yang. Apoory Kulshreshtha. Gaurav Nemade. Yifeng Lu. and Quoc V. Le. Towards a human-like open-domain chatbot. CoRR. abs/2001.09977. 2020; and Tom B Brown. Benjamin Mann. Nick Ryder. Melanie Subbiah. Jared Kaplan, Prafulla Dhariwal, Arvind Neelakantan. Pranav Shyam. Girish Sastry. Amanda Askell, et al. Language models are few-shot learners. arXiv preprint arXiv:2005.14165. 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, prior to using the neural network 110, the system 100 or another training system pre-trains the language model neural network 110 on a language modeling task, e.g., a task that requires predicting, given a current sequence of text tokens, the next token that follows the current sequence in the training data. As a particular example, the language model neural network 110 can be pre-trained on a maximum-likelihood objective on a large dataset of text, e.g., text that is publicly available from the Internet or another text corpus.

Generally, because the neural network 110 is auto-regressive, the system 100 can use the same neural network 110 to generate multiple different candidate output sequences 120 in response to the same request, e.g., by using beam search decoding from score distributions generated by the neural network 110, using a Sample-and-Rank decoding strategy, by using different random seeds for the pseudo-random number generator that's used in sampling for different runs through the neural network 110 or using another decoding strategy that leverages the auto-regressive nature of the neural network.

While language model neural networks can be used to generate high-quality text. they have difficulty with generating long-term semantic coherence due to the restricted size of their context windows, i.e., restricted length of the current input sequence at any given time step. In particular, language model neural networks apply self-attention over their inputs, meaning that the amount of memory required to generate a given output token scales quadratically with the number of tokens in the current input sequence. In other words, the amount of memory required to generate the next token in the output sequence is O(n²) (where n is the number of tokens in the current input sequence). Thus, due to the constrained memory space of the one or more computers on which the system 100 is deployed, the language model neural network 110 must operate with a limited context window size, i.e., with a limited maximum length for the current input sequence when generating any given token. When the current input sequence exceeds the context window size, the system 100 removes the earliest tokens in the current input sequence so that the length of the current input sequence fits into the context window size prior to processing the current input sequence using the neural network 110. For example, given the memory constraints described above, the context window size may be limited to 2048 tokens.

The textual works 150 that are required to be generated by the system 100, on the other hand, require many more tokens to be generated to effectively describe a long sequence of actions and interactions. Moreover, the textual works 150 are required to exhibit long-term semantic coherence, with entities referenced at one point in the textual work 150 being consistently referenced and described throughout the long textual work. Because of the limited context size, an entity that only appears outside of the current context window is unlikely to be correctly referenced by the language model 100.

To mitigate the problem of limited memory of the system 100 (and, therefore, of limited context window size), the system 100 generates the textual work 150 conditioned on the description 108 over multiple generation steps.

The generations steps are arranged in a hierarchy 120 and, at each generation step, the system 100 uses the language model neural network 110 to generate an output text sequence that contains information that is relevant to an aspect of the textual work 150. Each generation step is performed so that the current input sequences required to generate the output text sequence do not exceed the context window size, mitigating the impact of memory constraints on the quality of the textual work 150. At the highest layer of the hierarchy, the generation step(s) are performed conditioned on the description 108. At each other layer of the hierarchy, the generation steps are performed conditioned on one or more of the output sequences for one or more of the generation steps at higher layer(s) of the hierarchy.

More specifically, at the lowest layer of the hierarchy, the system 100 performs a respective generation step for each “section” in the textual work 150. For each section, the system 100 performs a generation step using the neural network 110 to generate the contents of the textual work 150 that correspond to the section. Because the outputs at higher layers of the hierarchy are relevant to multiple sections, by conditioning the steps at the lowest layer of the hierarchy on outputs from higher layers, the system 100 ensures that the outputs of the lowest layer are consistent with one another despite being generated independently from one another due to the memory constraints.

The system 100 then generates the final textual work 150 by combining, e.g., concatenating or appending, the outputs of the lowest-layer sections according to a specified order.

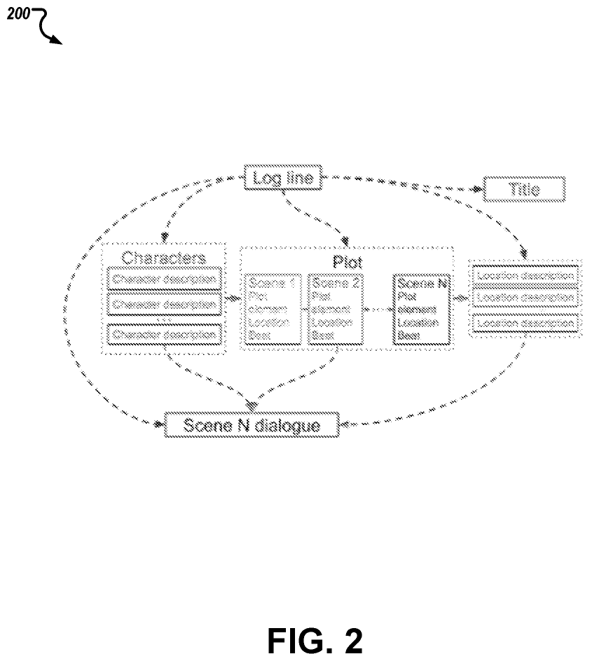

An example of a hierarchy is described below with reference to FIG. 2.

To be able to use the same neural network 100 to generate different outputs for different generation steps, i.e., to generate output sequences that describe different aspects that are relevant to the textual work 150, the system 100 can use different “prompts” for different generation steps.

More specifically, the system uses a different prompt as the context sequence for each generation step. Each prompt is a text sequence that includes one or more examples, with each example including (i) an example input for the generation step and (ii) an example output that should be generated by the neural network 110 for the generation step. The prompt also includes the input to the generation step that is generated based on the description 108, output sequences at earlier generation steps, or both. That is, for at least one layer in the hierarchy, to ensure consistency of the textual work, the input to the generation steps at the layer is generated based on output sequences for one or more higher layer in the hierarchy.

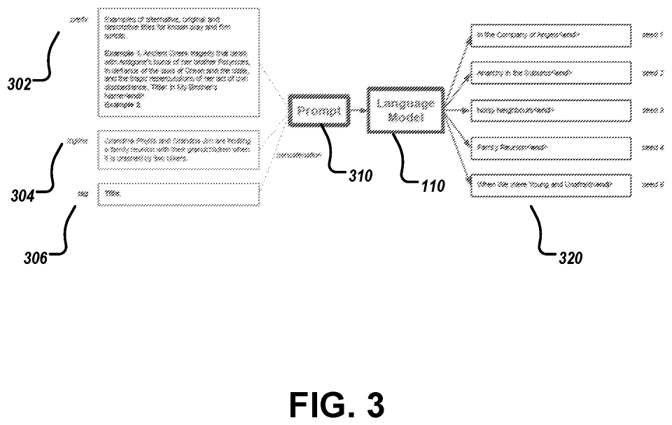

An example prompt is described below with reference to FIG. 3.

In some implementations, the system 100 performs one or more of the generation steps in an interactive manner. In particular, the system 100 can display to the user 102 on a user interface of the user device 104, the output text sequence that was generated by the neural network 110 for the generation step. The user 102 can then submit, through the user device 104, inputs that specify whether the output text sequence prior to being finalized.

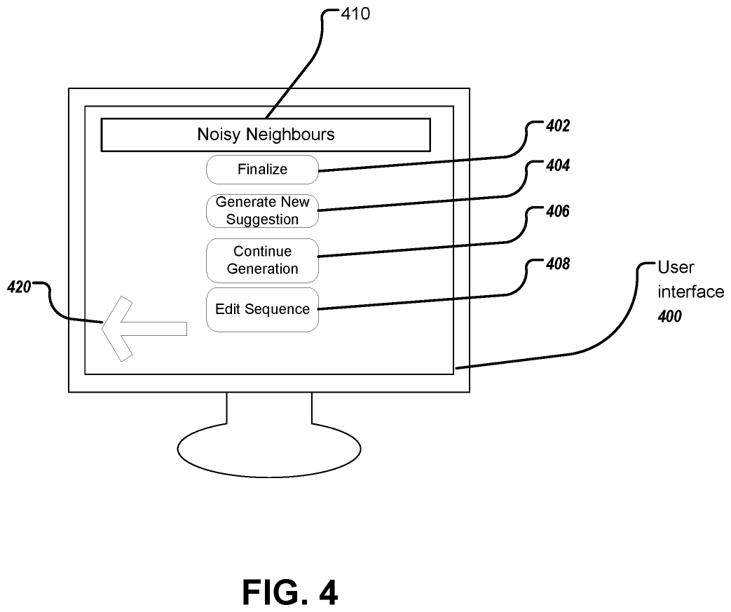

This is described below with reference to FIG. 4.

Performing generation steps in an interactive manner allows the user to refine the final content of the textual work 150 without requiring the user to compose the actual textual work 150. Thus, the user can effectively guide the generation of the textual work 150 in a time-efficient manner while still using the neural network 110 to generate the content of the textual work 150.

Once the textual work 150 is generated or as the textual work 150 is being generated, the system 100 can optionally use one or more other generative models to generate media content of one or more other modalities to accompany the textual work 150.

For example, the system 100 can use a text-to-speech model to generate audio of the textual work 150 being verbalized. When the textual work 150 includes multiple different speakers verbalizing different segments of the textual work 150, the system 100 can use the text-to-speech model to cause each segment of the work to be verbalized by the corresponding speaker, e.g., by conditioning the text-to-speech model on different speaker embeddings or on sample speech from different speakers.

As another example, the system 100 can use a text-conditional image generation model to generate images that represent the content of the textual work 150. For example, the system can generate text prompts from the outputs at one or more layers of the hierarchy and process each text prompt using a text-conditional image generation model, e.g., a text-conditional diffusion model, to generate respective images for each of one or more sections of the textual work 150.

As another example, the system 100 can use a text-conditional video generation model to generate a video that represents the content of the textual work 150. For example, the system can generate text prompts from the outputs at one or more layers of the hierarchy and process each text prompt using a text-conditional video generation model, e.g., a text-conditional diffusion model, to generate respective video segments for each of one or more sections of the textual work 150.

As another example, the system 100 can use a text-conditional multi-modal generative model to generate a multi-modal output that represents the content of the textual work 150. For example, the multi-modal output can include both audio and images or both audio and video. For example, the system 100 can generate text prompts from the outputs at one or more layers of the hierarchy and process each text prompt using a text-conditional multi-modal generative model, e.g., a text-conditional multi-modal diffusion model, to generate respective multi-modal outputs for each of one or more sections of the textual work 150.

The system 100 can then provide the generated media content for presentation to a user on a device, e.g., in addition to or instead of the textual work 150.

FIG. 2 is a diagram that shows one example of a hierarchy that can be used to generate a textual work.

In the example of FIG. 2, the system 100 is generating a textual work that includes dialogue between actors, e.g., a screenplay or theatrical script. However, a similar hierarchy can be used to generate many other different types of long textual works.

As shown in FIG. 2, the hierarchy has three hierarchical layers of abstraction.

The highest layer is the “log line,” also referred to as the description 108 with reference to FIG. 1. The log line can be generated by the system 100, e.g., by appropriately prompting the language model neural network 110, or can be received from the user.

The log line summarizes the textual work 150 in a small number of sentences and, in the case of a dialogue-driven textual work, typically contains information identifying properties of the narrative, e.g., one or more of setting, protagonist, antagonist, a conflict or goal, or the inciting incident. More generally, the log line contains the answers to questions (“Who? What? When and Where? How? Why?”) necessary to complete the content of the textual work.

The lowest layer is the actual character dialogue for the text of the textual work 150. In this way, content at each layer is coherent with, i.e., forms a unified whole with, content in other layers of the hierarchy.

As illustrated in FIG. 2, the textual work 150 is generated top-down. After the user provides the log line (or the system 100 generates the log line), the system 100 generates a list of characters, then a plot, and then descriptions of each location mentioned in the plot.

Characters, plot, and location descriptions all meet the specification in the log line, in addition to causal dependencies.

The system 100 can ensure that outputs generated by the language model neural network 100 for a given generation step satisfy causal dependencies and meet the specification in the log line by including information from previous generation steps (and the log line) in the prompt that is provided to the neural network at the given generation step.

Finally, for each section in the plot outline, the system generates dialogue satisfying previously generated section specifications. Resulting dialogues are appended together to generate the final textual work, enabling long-term semantic coherence.

As can be seen from FIG. 2, the hierarchy includes a middle layer that collectively generates an output that summarizes the plot of the textual work 150 as a sequence of abstract section (scene) descriptions. This allows the entire plot to fit within the language model's context window and overcomes prior limitations on long-term semantic coherence that were caused by memory constraints.

FIG. 3 shows an example of a prompt that is provided to the language model neural network 110 at a generation step that requires the neural network to generate a title from a log line.

As can be seen from FIG. 3, the prompt 310 includes a prefix 302, an input 304, and a tag 306 that concatenated together to generate the prompt 310.

The language model neural network 110 then processes the prompt 310 to generate a set of titles 320. In particular, the language model neural network 110 can generate multiple different titles from the same prompt by virtue of the stochasticity of the auto-regressive generation process. In other words, each title 320 was generated by sampling differently from the probability distributions generated by the neural network 110 at each time step. In the specific example of FIG. 3, each title 320 is generated by using a different random seed for the pseudo-random number generator that is used for the sampling.

The prefix 302 includes multiple different examples of the type of input that is processed at the generation step and a respective example output for each input example. In particular, in the example of FIG. 3, the prefix 302 includes a natural language description of the type of output that should be generated by the neural network 110 for the generation step (“Examples of alternative, original and descriptive titles for known play and film scripts.) The prefix 302 then includes multiple different examples, with the example input and the example output within each example being separated by a “tag” that identifies the generation time step (“Tag.”).

The input 304 is the actual input to this instance of the generation step. For example, for generating the title, the input 304 is the logline. For other generation steps, the input may be the output of one or more other generation steps, the logline, or both.

The tag 306 is included after the input 304 so that the format of the input 304 matches the format of the examples in the prefix 302.

Other generation steps have prompts that are the same format, but with the tags and prefixes being tailored for that generation step. That is, for other generation steps, the tag identifies the other generation step and the prefix include examples corresponding to the other generation step.

FIG. 4 shows an example of a user interface 400 that is provided for presentation on a user device by the system 100.

In particular, the system 100 provides the user interface 400 for presentation to the user after an initial output sequence for a particular generation step has been generated by the system 100.

The user interface 400 shows the current output sequence 410 for the particular generation time step and provides the user several choices that will all cause the system 100 to proceed in different way.

In particular, one option that is presented to the user in the user interface 400 is the “finalize” option 402. In response to the user submitting an input selecting the “finalize” option, the system 100 uses the current output sequence 410 as the output sequence for the particular generation step and proceeds to the next generation step. A user can submit an input selecting an option in any appropriate way, e.g., submitting a touch input or an input device input selecting an icon corresponding to the option or speaking a voice command identifying the option.

Another option that is presented to the user in the user interface 400 is the “generate new suggestion” option 404. In response to the user submitting an input selecting the “generate new suggestion” option, the system 100 updates the current output sequence 410 by processing the same prompt using the neural network 110 and setting the new output sequence as the current output sequence 410. As described above, the system 100 can generate different outputs from the same prompt using the neural network 110 in any of a variety of ways.

Another option that is presented to the user is the “continue generation” option 406. In response to the user submitting an input selecting the “continue generation” option, the system 100 updates the current output sequence 410 by processing a new input that includes the current output sequence 410 using the neural network 110 to generate a new output sequence that is a continuation of the current output sequence 410 and appending the new output sequence to the current output sequence 410.

Another option that is presented to the user is the “edit sequence” option 408. In response to the user submitting an input selecting the “edit sequence” option, the system 100 allows the user submit inputs updating the current output sequence 410, e.g., by adding, modifying, or deleting the text tokens in the current output sequence 410 through the user interface.

The system 100 can continue to update the user interface 400 in response to user inputs until the user selects the “finalize” option 402, at which point the system 100 proceeds to the next generation step.

Optionally, the user interface 400 can include a control 430 that, when selected, allows the user to move back from the particular generation step to previous generation steps, i.e., to modify the outputs of previous generation steps as described above. This can be advantageous when the output from a previous generation step is adversely impacting the quality of the output of the current generation step, i.e., by directly or indirectly modifying the input to the current generation step.

Thus, through the user interface 400, the user can effectively interact with the system 100 to “shape” the textual work 150 as the textual work is being generated without needing to manually rewrite the text of the actual textual work. “Shaping” the textual work 150 in this way ensures that the user only has to make a given change one time and the change will be coherently propagated through the entire final text of the textual work 150.

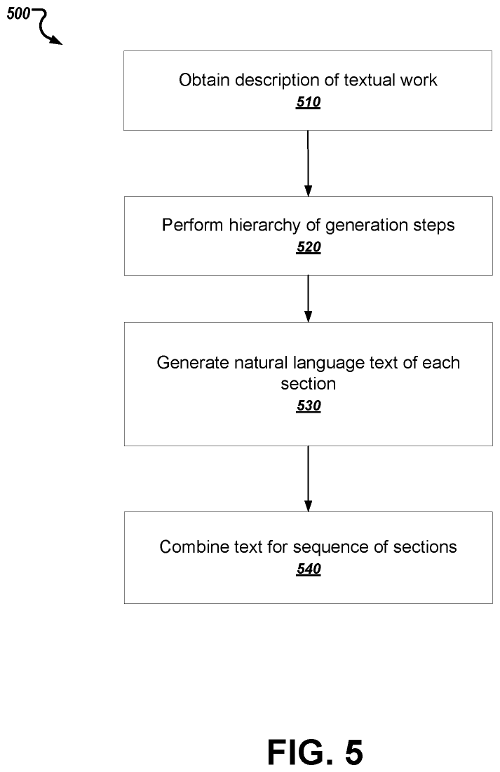

FIG. 5 is a flow diagram of an example process 500 for generating a textual work using a language model neural network. For convenience, the process 500 will be described as being performed by a system of one or more computers located in one or more locations. For example, a textual work generation system, e.g., the textual work generation system 100 depicted in FIG. 1, appropriately programmed in accordance with this specification, can perform the process 500.

The system obtains a description of the textual work (step 502). The description is a natural language text segment that describes the desired content of the textual work. For example, the system can receive the description from a user or can randomly generate the description.

The system performs a hierarchy of generation steps to generate a respective summary of each of a sequence of sections within the textual work conditioned on the textual work (step 504). As described above, each generation step is performed using the language model neural network and is structured so that the required context inputs for the generation step fit within the context window of the neural network.

For each section in the sequence, the system generates the text of the section in the textual work using the respective summary of the section (step 506). In particular, the system processes an input that includes a prompt that is derived from the respective summary of the section using the language model neural network to generate, as output, the text of the section.

The system combines the text of the sections to generate the textual work (step 508), i.e., by appending the section text one after the other.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g., use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA: Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g., a dot product or scaled dot product, of the query with the corresponding key.

Generally, a self-attention mechanism is configured to relate different positions in the same sequence to determine a transformed version of the sequence as an output. For example, the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation, e.g., defined by a matrix W^{Q}, a key transformation, e.g., defined by a matrix W^{K}, and a value transformation, e.g., defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example, the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor, e.g., by the square root of the dimensions of the queries and keys, to implement scaled dot product attention. Thus, for example, an output of the attention mechanism may be determined as

$$softmax ( \frac{{QK}^{T}}{\sqrt{d}} ) V$$

where d is a dimension of the key (and value) vector. In another implementation the attention mechanism comprises an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g., concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by. or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages: and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks: and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a natural language description for a textual work;
performing a hierarchy of generation steps to generate a respective natural language summary of each of a plurality of sections of the textual work, wherein performing each generation step comprises:
processing an input for the generation step that is derived from (i) the natural language description for the textual work, (ii) an output of a preceding generation step within the hierarchy of generation steps, or (iii) both using a language model neural network to generate a natural language sequence output for the generation step;
for each section in the sequence, processing an input for the section that is derived from the respective natural language summary of the section using the language model neural network to generate natural language text of the section from the textual work; and
generating, as output, the textual work by combining the respective natural language text of each of the sections in the sequence.

2. The method of claim 1, wherein the textual work is a narrative and the plurality of sections of the textual work are a plurality of scenes of the narrative.

3. The method of claim 1, wherein obtaining a natural language description for a narrative comprises:
obtaining the natural language description as input from a user.

4. The method of claim 1, further comprising:
providing the generated narrative for presentation on a user device.

5. The method of claim 1, wherein performing a particular one of the generation steps comprises:
generating, from the input to the generation step, a prompt for the generation step;
processing the prompt using the language model neural network to generate an initial output sequence for the generation step:
providing, for presentation in a user interface on a user device, the initial output sequence:
receiving, from the user device, a user input requesting a modification to the initial output sequence: and
in response to receiving the user input, modifying the initial output sequence.

6. The method of claim 5, wherein receiving, from the user device, a user input requesting a modification to the initial output sequence comprises:
receiving a request to generate a new suggestion for the generation step, and wherein in response to receiving the user input, modifying the initial output sequence comprises:
performing another instance of processing the prompt using the language model neural network to generate a new output sequence for the generation step.

7. The method of claim 5, wherein receiving, from the user device, a user input requesting a modification to the initial output sequence comprises:
receiving a request to generate a continuation of the initial output sequence for the generation step, and wherein in response to receiving the user input, modifying the initial output sequence comprises:
processing a new input comprising the initial output sequence using the language model neural network to generate a new output sequence for the generation step: and
concatenating the initial output sequence and the new output sequence.

8. The method of claim 5, wherein receiving, from the user device, a user input requesting a modification to the initial output sequence comprises:
receiving an edited output sequence from the user device, and wherein in response to receiving the user input, modifying the initial output sequence comprises:
setting the initial output sequence equal to the edited output sequence.

9. The method of claim 1, wherein, for each generation step, the input for the generation step comprises a prompt that is a concatenation of at least:
a prefix that comprises one or more examples, each example comprising (i) an example input for the generation step and (ii) an example output corresponding to the example input: and
input text that is derived from (i) the natural language description for the narrative, (ii) an output of a preceding generation step within the hierarchy of generation steps, or (iii) both.

10. The method of claim 9, wherein, within each example, the example input is separated from the example output by a natural language tag identifying the generation step and wherein the prefix also includes the natural language tag following the input text.

11. The method of claim 1, wherein the same language model neural network is used to perform each generation step and to generate the respective text of each of the sections.

12. One or more non-transitory computer-readable storage media storing instructions that when executed by one or more computers cause the one or more computers perform operations comprising:
obtaining a natural language description for a textual work:
performing a hierarchy of generation steps to generate a respective natural language summary of each of a plurality of sections of the textual work, wherein performing each generation step comprises:
processing an input for the generation step that is derived from (i) the natural language description for the textual work, (ii) an output of a preceding generation step within the hierarchy of generation steps, or (iii) both using a language model neural network to generate a natural language sequence output for the generation step:
for each section in the sequence, processing an input for the section that is derived from the respective natural language summary of the section using the language model neural network to generate natural language text of the section from the textual work: and
generating, as output, the textual work by combining the respective natural language text of each of the sections in the sequence.

13. A system comprising one or more computers and one or more storage devices storing instructions that when executed by the one or more computers cause the one or more computers to perform operations comprising:
obtaining a natural language description for a textual work:
performing a hierarchy of generation steps to generate a respective natural language summary of each of a plurality of sections of the textual work, wherein performing each generation step comprises:
processing an input for the generation step that is derived from (i) the natural language description for the textual work, (ii) an output of a preceding generation step within the hierarchy of generation steps, or (iii) both using a language model neural network to generate a natural language sequence output for the generation step:
for each section in the sequence, processing an input for the section that is derived from the respective natural language summary of the section using the language model neural network to generate natural language text of the section from the textual work: and
generating, as output, the textual work by combining the respective natural language text of each of the sections in the sequence.

14. The system of claim 13, wherein the textual work is a narrative and the plurality of sections of the textual work are a plurality of scenes of the narrative.

15. The system of claim 13, wherein obtaining a natural language description for a narrative comprises:
obtaining the natural language description as input from a user.

16. The system of claim 13, the operations further comprising:
providing the generated narrative for presentation on a user device.

17. The system of claim 13, wherein performing a particular one of the generation steps comprises:
generating, from the input to the generation step, a prompt for the generation step:
processing the prompt using the language model neural network to generate an initial output sequence for the generation step:
providing, for presentation in a user interface on a user device, the initial output sequence:
receiving, from the user device, a user input requesting a modification to the initial output sequence: and
in response to receiving the user input, modifying the initial output sequence.

18. The system of claim 17, wherein receiving, from the user device, a user input requesting a modification to the initial output sequence comprises:
receiving a request to generate a new suggestion for the generation step, and wherein in response to receiving the user input, modifying the initial output sequence comprises:
performing another instance of processing the prompt using the language model neural network to generate a new output sequence for the generation step.

19. The system of claim 17, wherein receiving, from the user device, a user input requesting a modification to the initial output sequence comprises:
receiving a request to generate a continuation of the initial output sequence for the generation step, and wherein in response to receiving the user input, modifying the initial output sequence comprises:
processing a new input comprising the initial output sequence using the language model neural network to generate a new output sequence for the generation step: and
concatenating the initial output sequence and the new output sequence.

20. The system of claim 17, wherein receiving, from the user device, a user input requesting a modification to the initial output sequence comprises:
receiving an edited output sequence from the user device, and wherein in response to receiving the user input, modifying the initial output sequence comprises:
setting the initial output sequence equal to the edited output sequence.
